(19) United States
(12) Patent Application Publication
(10) Pub. No.: US 2007/0296827 A1
(43) Pub. Date: Dec. 27, 2007

(54) Head detachable camera, camera head and camera control unit

(75) Inventors: Akihiko Kubota, Tokyo (JP); Hidetaka Nakamura, Tokyo (JP); Hiroyuki Ishino, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/804,465

(22) Filed: May 18, 2007

(30) Foreign Application Priority Data
Jun. 21, 2006 (JP) P2006-171657

(51) Int. Cl. H04N 5/228

(52) U.S. Cl. 348/222.1; 348/E05.031

(57) ABSTRACT

According to one embodiment, a camera control unit constituting a head detachable camera includes plural drive signal generators generating a drive signal different by each format of an image pickup device, plural video signal generators generating a video signal different by each format of the image pickup device, and plural converters converting the video signal into an output format different by each format of the image pickup device. Besides, the camera control unit switches the drive signal generator, video signal generator, and converter to be activated in accordance with the format of the image pickup device from among the plural drive signal generators, video signal generators, and converters.

### CROSS-REFERENCE TO RELATED APPLICATIONS

This application is based upon and claims the benefit of priority from Japanese Patent Application No. 2006-171657, filed Jun. 21, 2006, the entire contents of which are incorporated herein by reference.

### BACKGROUND

1. Field

One embodiment of the invention relates to a head detachable camera having a constitution in which a camera head and a camera control unit are detachable, and to the camera head and camera control unit constituting the head detachable camera.

2. Description of the Related Art

Conventionally, there is a head detachable camera as a small-sized camera using an image pickup device such as a CCD (Charge Coupled Device).

The head detachable camera generally has a camera head (referred to as a head) outputting an image pickup signal obtained by the image pickup device such as the CCD, and a camera control unit (hereinafter, referred to as a “CCU”) including a signal processing circuit to obtain a video signal for display based on the image pickup signal from the camera head, and has a constitution in which the head and the CCU are connected by a dedicated camera cable.

Besides, the head detachable camera guides the video signal outputted from the CCU to a display device, and a subject captured by the head can be observed by image display on the display device.

As for a conventional head detachable camera, for example, a television camera device as follows is disclosed in Japanese Patent Application Publication (KOKAI) No. 2005-101700 (Patent Document 1). This television camera device converts a video signal transmitted from a head into various formats, to select and output the video signal after conversion by a signal selection circuit provided corresponding to each signal output terminal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1(a) to 1(c) are exemplary block diagrams showing configurations of a head detachable camera, in which FIG. 1(a) shows a case when a camera head 51 is connected, FIG. 1(b) shows a case when a camera head 52 is connected, and FIG. 1(c) shows a case when a camera head 53 is connected according to an embodiment of the invention;

FIG. 2 is an exemplary block diagram showing an internal configuration of a CCU constituting the head detachable camera in the embodiment;

FIG. 3 is an exemplary block diagram in which an essential configuration to make the head detachable camera multi-head type is shown mainly from among the internal configuration of the CCU, and other configurations are not shown in the embodiment;

FIG. 4 is an exemplary block diagram showing an oscillation circuit, MPU, and timing generator in the embodiment;

FIG. 5 is an exemplary block diagram showing another oscillator, and timing generator in the embodiment;

FIG. 6 is an exemplary block diagram showing configurations of the camera heads in the embodiment;

FIG. 7 is an exemplary flowchart showing an operating procedure of a switching process in the embodiment;

FIGS. 8(a) to 8(c) are exemplary views showing examples of main performance characteristics of the CCU, in which FIG. 8(a) is a view showing an example of characteristics of a generation of a drive signal by the timing generator, FIG. 8(b) is a view showing an example of characteristics of a signal process by a digital signal processor, and FIG. 8(c) is a view showing an example of characteristics of a format conversion by an output format converter in the embodiment;

FIG. 9 is an exemplary view showing that two performances of a rise and fall of frame rate and a rise and fall of resolution are conflicting in the embodiment;

FIG. 10 is an exemplary view showing that two performances of a rise and fall of sensitivity and the rise and fall of resolution are conflicting in the embodiment;

FIG. 11 is an exemplary block diagram showing a configuration of a conventional head detachable camera; and

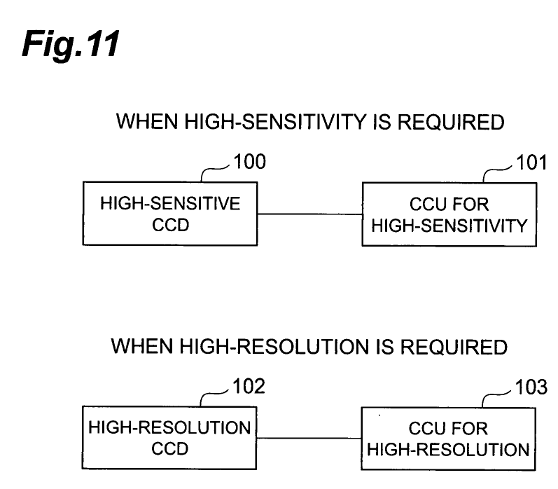

FIGS. 12(a) and 12(b) are exemplary views showing examples of performance characteristics of the CCU, in which FIG. 12(a) is a view showing the performance characteristics of a conventional CCU corresponding to CCDs having different inch sizes, and FIG. 12(b) is a view showing the performance characteristics of the CCU of the present invention corresponding to CCDs having the same sizes.

### DETAILED DESCRIPTION

Various embodiments according to the invention will be described hereinafter with reference to the accompanying drawings. In general, according to one embodiment of the invention, a camera control unit constituting a head detachable camera includes: plural drive signal generators generating a drive signal different by each format of an image pickup device; plural video signal generators generating a video signal different by each format of the image pickup device; plural converters converting the video signal into an output format different by each format of the image pickup device. Besides, the camera control unit switches the drive signal generator, the video signal generator, and the converter to be activated in accordance with the format of the image pickup device, from among the plural drive signal generators, video signal generators, and converters.

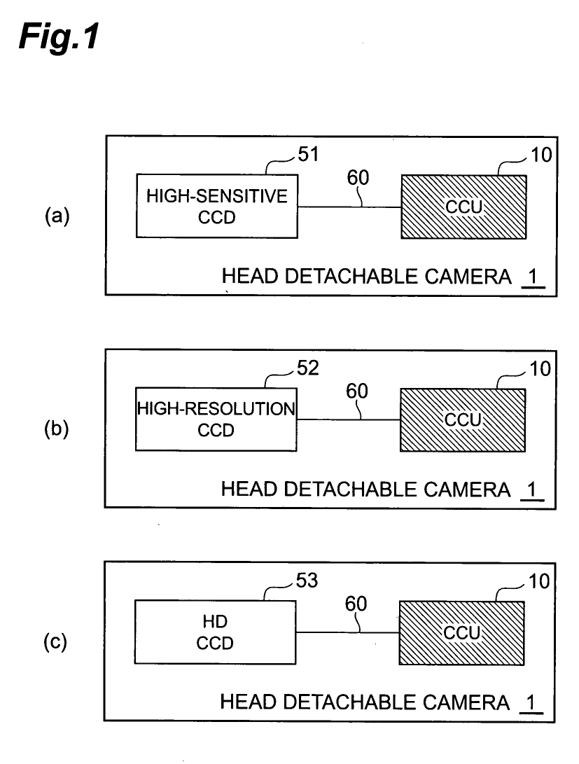

FIGS. 1(a) to 1(c) are block diagrams showing configurations of a head detachable camera 1 in the present embodiment. The head detachable camera 1 in the present embodiment is a multi head type having a constitution capable of connecting several types of heads with one CCU.

A CCU 10 has a constitution corresponding that plural camera heads 51, 52, 53 having different formats of CCD (hereinafter, referred to as a “CCD format”) as an image pickup device are connected, as respectively shown in FIGS. 1(a), 1(b), 1(c). Accordingly, in the head detachable camera 1, the plural camera heads 51, 52, 53 having different CCD formats can be connected to the same CCU 10 via a camera cable 60.

For example, the head detachable camera 1 is able to connect the camera head 51 having a high-sensitive CCD to the CCU 10, and the camera head 52 having a high-resolution CCD to the CCU 10. Besides, the head detachable camera 1 is also able to connect the camera head 53 having an HD (High Definition) CCD to the CCU 10.

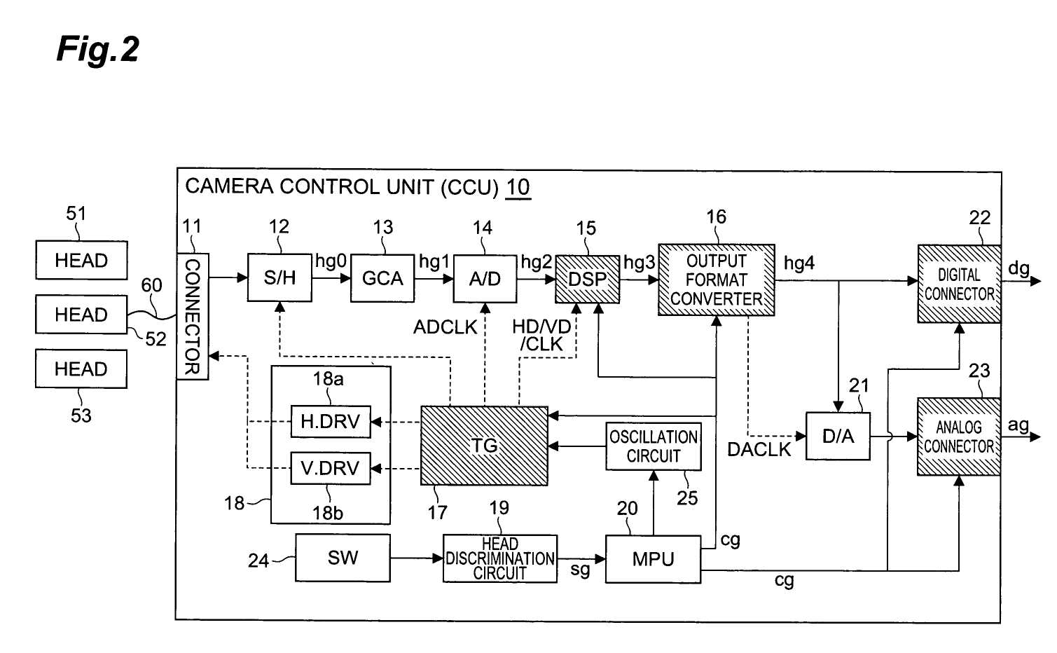

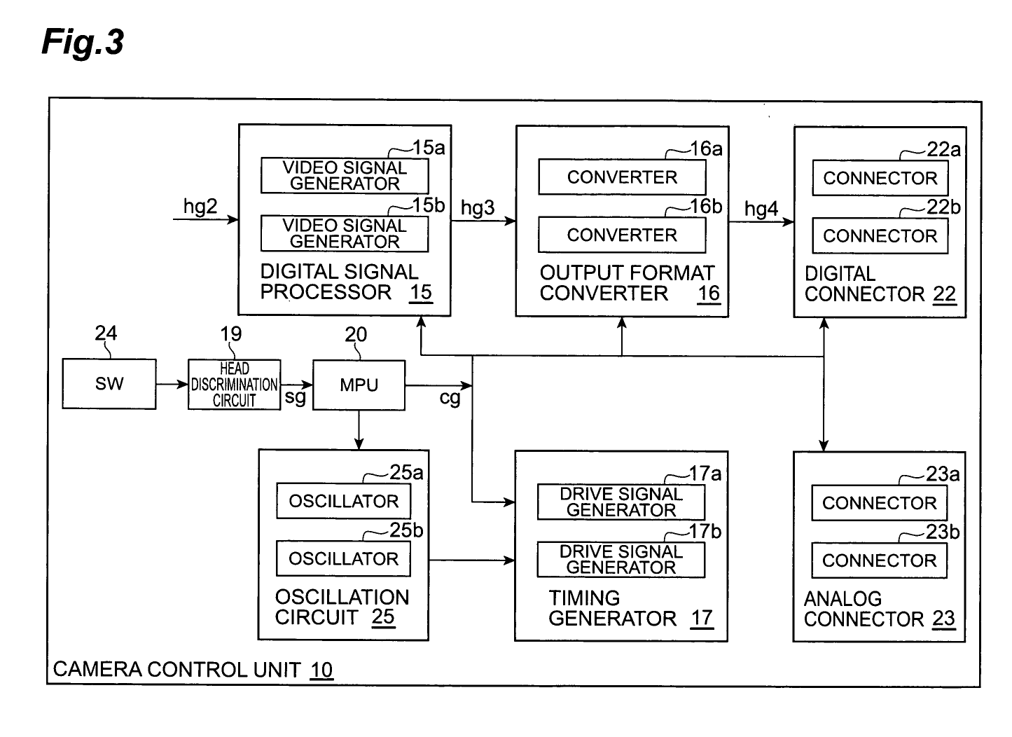

FIG. 2 is a block diagram showing an internal configuration of the CCU 10 constituting the head detachable camera 1. Besides, FIG. 3 is a block diagram in which an essential configuration to make the head detachable camera 1 multi head type is shown mainly from among the internal configuration of the CCU 10, and other configurations are not shown. Incidentally, FIG. 3 shows the configuration in which the plural camera heads 51, 52 are assumed to be connected.

As shown in FIG. 2, the CCU 10 has a connector 11, a sampling hold circuit (S/H) 12, a gain control amplifier (GCA) 13, an AD converter (A/D) 14, and a digital signal processor (DSP) 15.

Besides, the CCU 10 has an output format converter 16, a timing generator (TG) 17, a drive signal output circuit 18, a head discrimination circuit 19, an MPU (Micro Processing Unit) 20, a DA converter (D/A) 21, a digital connector 22, and an analog connector 23. Further, the CCU 10 has a manual switch (SW) 24, and an oscillation circuit 25.

The camera cable 60 is connected to the connector 11. The connector 11 has plural not-shown connection terminals corresponding to the camera cable 60.

The sampling hold circuit (S/H) 12 inputs an output signal in pixel unit outputted from the CCD of the connected camera head (hereinafter, the camera heads 51, 52 are explained as examples) via the connector 11, and outputs an image pickup signal hg0 by performing a sample-hold operation.

The gain control amplifier 13 amplifies the image pickup signal hg0 outputted from the sampling hold circuit 12, to output an image pickup signal hg1. The AD converter 14 inputs an AD clock signal (ADCLK) outputted from the timing generator 17, converts the amplified image pickup signal hg1 into a digital signal to output an image pickup signal hg2.

The digital signal processor 15 constitutes a video signal generation unit together with the sampling hold circuit (S/H) 12, the gain control amplifier 13, and the AD converter 14. This digital signal processor 15 inputs a clock synchronization signal (CLK), an HD signal, a VD signal outputted from the timing generator 17, performs a predetermined digital signal process for the image pickup signal hg2 converted into the digital signal, and outputs a video signal hg3 to display video on a not-shown display device. Besides, the digital signal processor 15 includes later-described plural video signal generators 15a, 15b generating the video signal hg3 which is different by each CCD format of the camera head, as shown in FIG. 3.

The output format converter 16 is a format conversion unit, and it converts an output format of the video signal hg3 generated at the digital signal processor 15 to output a video signal hg4. Besides, the output format converter 16 has later-described plural converters 16a, 16b converting the video signal hg3 into an output format different by each CCD format, as shown in FIG. 3.

The timing generator 17 is a drive signal generation unit, and it is constituted by using an FPGA (Field Programmable Gate Array) and so on. This timing generator 17 outputs various timing signals, including a horizontal CCD drive pulse as a drive signal to drive the CCD of the camera head, to the drive signal output circuit 18. This timing generator 17 has later-described plural drive signal generators 17a, 17b generating the drive signal different by each CCD format of the camera head, as shown in FIG. 3.

The drive signal output circuit 18 has a horizontal CCD drive (H. DRV) 18a and a vertical CCD drive (V. DRV) 18b. The drive signal to drive the CCD is outputted from the horizontal CCD drive (H. DRV) 18a and the vertical CCD drive (V. DRV) 18b to the camera heads (camera heads 51, 52) connected via the connector 11 and the camera cable 60.

The head discrimination circuit 19 is a discrimination unit, and it discriminates the CCD format of the camera head (for example, the camera head 51) connected via the camera cable 60, and outputs a discrimination signal sg showing a discrimination result to the MPU 20.

The MPU 20 is a switching unit, and it outputs a switch control signal cg to the digital signal processor 15, output format converter 16, and timing generator 17, based on the discrimination signal sg outputted from the head discrimination circuit 19.

The MPU 20 switches the video signal generators 15a, 15b, the converters 16a, 16b, and the drive signal generators 17a, 17b to be activated (either the video signal generator 15a, converter 16a, and drive signal generator 17a are to be activated, or the video signal generator 15b, converter 16b, and drive signal generator 17b are to be activated) by outputting the switch control signal cg, so that an operation complying with the CCD format is to be performed. Besides, the MPU 20 also outputs the switch control signal cg to the digital connector 22 and the analog connector 23, and outputs a later-described operation signal to the oscillation circuit 25.

The DA converter (D/A) 21 converts the video signal hg4 into an analog signal and outputs to the analog connector 23. The digital connector 22 is a connection terminal to output the digital video signal hg4 to external, and the analog connector 23 is a connection terminal to output the analog video signal hg4 to external.

The manual switch 24 is, for example, attached to a main body of the CCU 10, and it is constituted such that a user can perform a slide operation manually in accordance with the connected type of head.

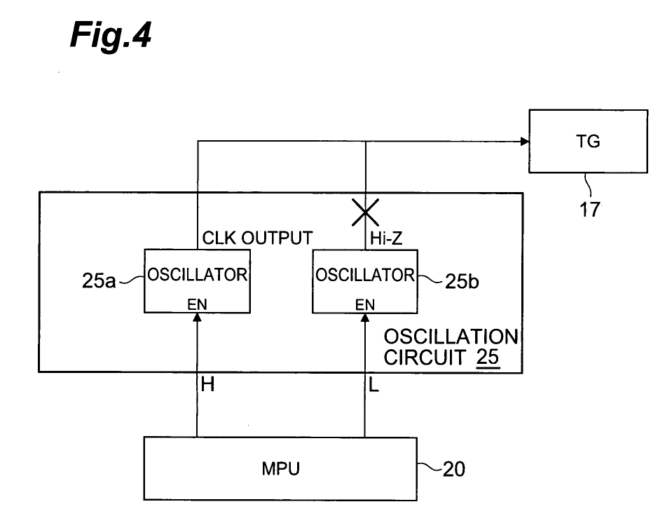

The oscillation circuit 25 has plural oscillators 25a, 25b oscillating with different frequencies by the respective CCD formats, as shown in FIG. 4.

Operation contents of the head detachable camera 1 having the constitution as stated above are described while focusing on operation contents of the CCU 10.

1) Discrimination of CCD Format

At first, at the CCU 10, the CCD format of the connected camera head is discriminated by the head discrimination circuit 19. Here, the head discrimination circuit 19 discriminates the CCD format based on the operation signal from the manual switch 24.

When the user operates the manual switch 24, the signal in accordance with the operation (operation signal) is outputted from the manual switch 24 to the head discrimination circuit 19 (for example, when an operation showing that the camera head 51 is connected is performed, the signal is “1”, and when an operation showing that the camera head 52 is connected is performed, the signal is “2”, or the like).

The head discrimination circuit 19 discriminates the CCD format of the connected head based on the operation signal, and outputs the discrimination signal sg showing the discrimination result.

Besides, the head discrimination circuit 19 may discriminate the CCD format not by the operation signal from the manual switch 24, but in accordance with a vacant terminal of the camera cable 60. In this case, for example, the vacant terminal of the camera cable 60 when the camera head 51 is connected is set to GND, and the vacant terminal when the camera head 52 is connected is set to OPEN.

Accordingly, when the camera heads 51, 52 are connected to the camera cable 60, the vacant terminal changes in accordance with the connected camera head, and therefore, the head discrimination circuit 19 can discriminate the CCD format of the connected head based on an input signal from the vacant terminal. Incidentally, when the vacant terminal of the camera cable 60 is used, the more vacant terminals become necessary for that much if the number of camera heads connected to the CCU 10 increases.

Further, the head discrimination circuit 19 may read information capable of specifying the CCD format (format information) from a storage device included in the camera head (for example, EEPROM: Electrically Erasable Programmable Read-Only Memory), to discriminate the CCD format based on the read format information.

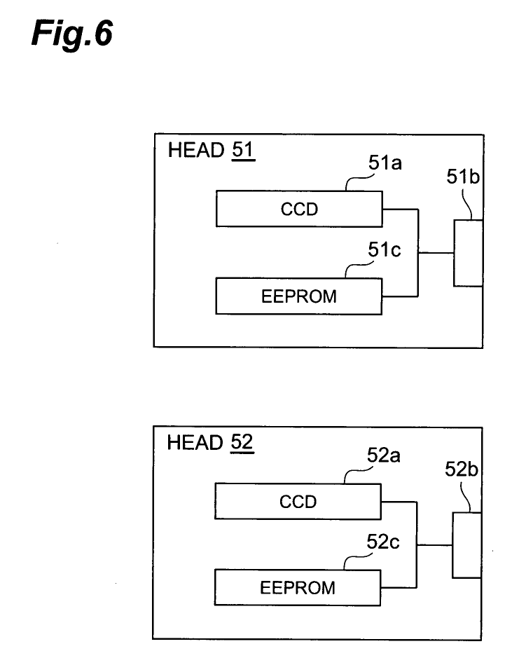

In this case, the camera heads 51, 52 are constituted as shown in FIG. 6. Here, the camera head 51 has a CCD (high-sensitive CCD) 51a, a connector 51b connecting the camera cable 60, and an EEPROM 51c. Besides, the camera head 52 has a CCD (high-resolution CCD) 52a, a connector 52b connecting the camera cable 60, and an EEPROM 52c. The information (format information) capable of specifying the formats of the CCD 51a, CCD 52a are respectively stored in the EEPROMs 51c, 52c.

For example, when the camera head 51 is connected to the camera cable 60, the MPU 20 operates as a format information reading unit, reads the stored format information from the EEPROM 51c, and inputs to the head discrimination circuit 19. The head discrimination circuit 19 can then discriminate the CCD format based on the inputted format information.

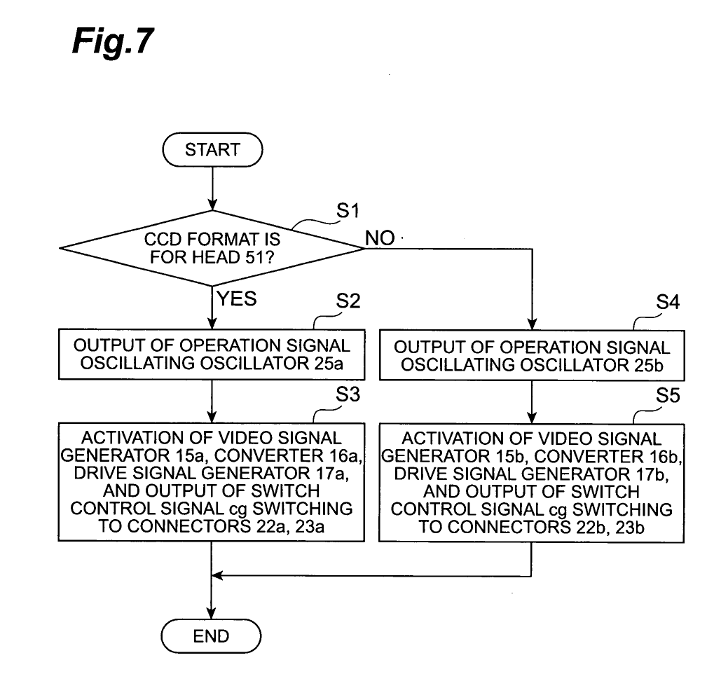

Next, the MPU 20 executes a switching process following a flowchart shown in FIG. 7, when the discrimination signal sg is inputted from the head discrimination circuit 19. Operations of the digital signal processor 15, output format converter 16, timing generator 17, and so on are switched by this switching process, and the generated drive signal and the generated and outputted video signal hg4 become appropriate ones complying with the CCD format of the connected camera head.

When the switching process is started, the MPU 20 advances the process to a block 1, it determines whether or not the discrimination signal sg is the CCD format for the camera head 51, then the process is advanced to a block 2 when it is the CCD format for the camera head 51, and otherwise, the process is advanced to a block 4.

When the MPU 20 advances the process to the block 2, it outputs an operation signal to oscillate the oscillator 25a. Subsequently, the MPU 20 advances the process to a block 3, activates the video signal generator 15a, converter 16a, and drive signal generator 17a, and outputs the switch control signal cg to switch the output connectors to connectors 22a, 23a.

On the other hand, when the MPU 20 advances the process to the block 4, it outputs the operation signal to oscillate the oscillator 25b. When the process is advanced to a subsequent block 5, the MPU 20 activates the video signal generator 15b, converter 16b, and drive signal generator 17b, and outputs the switch control signal cg to switch the output connectors to connectors 22b, 23b.

Here, each of oscillators 25a, 25b of the oscillation circuit 25 has an EN (Enable) terminal, and the operation signal is to be inputted to each EN terminal. The oscillators 25a, 25b are constituted such that fundamental frequencies of the drive and signal process are different, and the respective fundamental frequencies are to comply with the CCD formats of the connected camera heads.

When the camera head 51 is connected, the operation signal which turns the EN terminal of the oscillator 25a into H (High), and turns the EN terminal of the oscillator 25b into L (Low) is outputted at the block 2. Accordingly, only the oscillator 25a oscillates, and an output of the oscillator 25b becomes Hi-z.

Besides, when the camera head 52 is connected, the operation signal which turns the EN terminal of the oscillator 25b into H (High), and turns the EN terminal of the oscillator 25a into L (Low) is outputted at the block 4. Accordingly, only the oscillator 25b oscillates, and an output of the oscillator 25a becomes Hi-z.

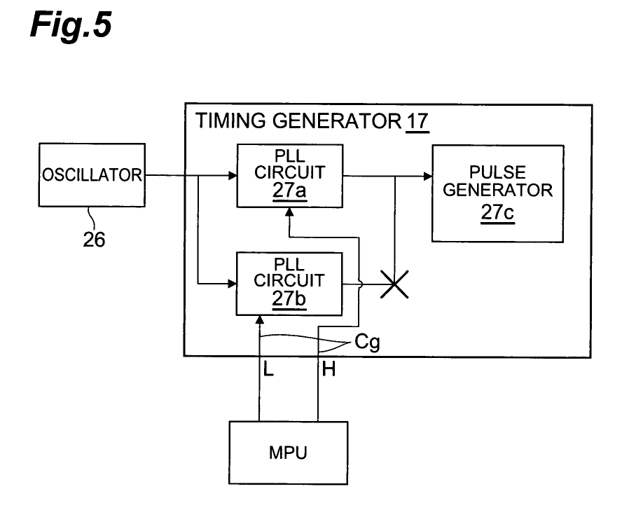

Instead of providing the oscillators 25a, 25b in the oscillation circuit 25 as stated above, different PLL circuits 27a, 27b, and a pulse generator 27c may be provided in the timing generator 17 to switch oscillation frequencies as shown in FIG. 5.

In this case, an oscillator 26 which oscillates at a certain frequency may be provided instead of the oscillation circuit 25, and either one of the PLL circuits 27a, 27b inside of the FPGA is activated by the switch control signal cg from the MPU 20. For example, the switch control signals cg which turn the PLL circuit 27a into H (High) and turn the PLL circuit 27b into L (Low) are inputted as shown in FIG. 5. It is also possible to switch the fundamental frequencies of the generation of the drive signal and the signal process as same as the case when the oscillation circuit 25 is provided.

Incidentally, the PLL circuit is not limited to the one inside of the FPGA, but an external PLL circuit may be used. Besides, the oscillator 26 may be provided in another FPGA from the timing generator 17, as shown in FIG. 5, but may be provided in the same FPGA.

2) Generation of Drive Signal

The drive signal is generated by the timing generator 17, and outputted from the drive signal output circuit 18 to the camera head via the connector 11 and the camera cable 60. However, as stated above, the configuration to be activated is switched between the drive signal generator 17a and drive signal generator 17b in the timing generator 17 by the switch control signal cg from the MPU 20, and either one of the drive signal generators 17a, 17b is to be activated. Accordingly, different drive signals are generated depending on the connected camera heads.

For example, when the camera head 51 is connected, the drive signal generator 17a is activated, and the appropriate drive signal complying with the CCD format of the camera head 51 is generated. Besides, when the camera head 52 is connected, the drive signal generator 17b is activated, and the appropriate drive signal complying with the CCD format of the camera head 52 is generated. The drive signal generators 17a, 17b having the function as stated above can be realized by, for example, plural drive signal generation programs to generate the drive signal complying with each CCD format.

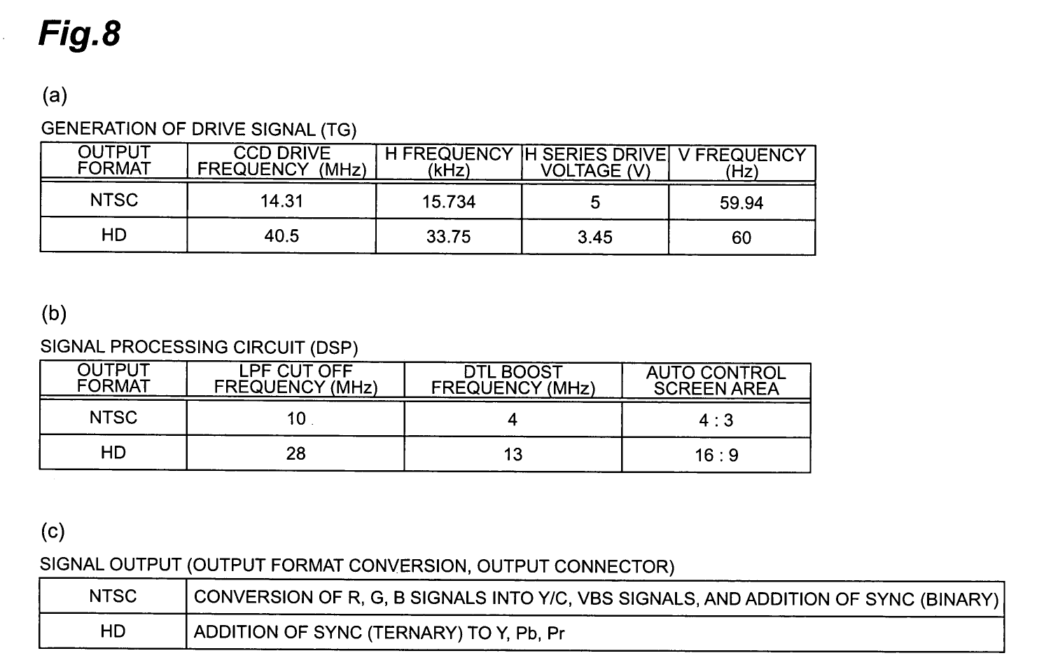

In this case, the high-sensitive CCD is incorporated in the camera head 51, the high-resolution CCD is incorporated in the camera head 52, and therefore, the drive signals generated to correspond thereto have characteristics, for example, as shown in FIG. 8(a). Incidentally, an output format “NTSC” in FIG. 8(a) shows a case when the camera head 51 is connected, and “HD” shows a case when the camera head 52 is connected (it is also the same as in FIGS. 8(b), 8(c)).

3) Signal Process (Generation of Video Signal)

As stated above, the video signal hg3 is generated by the digital signal processor 15. However, the configuration to be activated is switched between the video signal generator 15a and video signal generator 15b in the digital signal processor 15 by the switch control signal cg from the MPU 20. Besides, either one of the video signal generators 15a, 15b is to be activated. Accordingly, the video signal hg3 different by the connected camera head is generated.

In this case, when the camera head 51 is connected, the video signal generator 15a is activated, and the appropriate video signal hg3 complying with the CCD format of the camera head 51 is generated. Besides, when the camera head 52 is connected, the video signal generator 15b is activated, and the appropriate video signal hg3 complying with the CCD format of the camera head 52 is generated. The video signals hg3 generated as stated above have characteristics, for example, as shown in FIG. 8(b).

The video signal generators 15a, 15b perform the signal processes for the image pickup signal hg2 by the FPGA and so on. Namely, the video signal generators 15a, 15b perform an LPF, DTL (Detail process), AUTO series (Auto White Balance, Auto Electrical Sutter) processes, output signal generation (RGB output, YpbPr output), and so on. The video signal generators 15a, 15b having the functions as stated above can be realized by, for example, plural video signal generation programs to generate the appropriate video signal hg3 complying with each CCD format.

4) Output Format Conversion

The output format of the video signal hg3 is converted by the output format converter 16. However, the configuration to be activated is switched between the converter 16a and converter 16b in the output format converter 16 by the switch control signal cg from the MPU 20. Besides, either one of the converters 16a, 16b is to be activated. Accordingly, the video signal hg3 is converted into the output format different by the connected camera head, to be the video signal hg4.

In this case, when the camera head 51 is connected, the converter 16a is activated, and the video signal hg4 in the appropriate output format complying with the CCD format of the camera head 51 is generated. Besides, when the camera head 52 is connected, the converter 16b is activated, and the video signal hg4 in the appropriate output format complying with the CCD format of the camera head 52 is generated.

Both converters 16a, 16b convert the video signal hg3 into the appropriate output format capable of synchronizing in a not-shown display device, to generate the video signal hg4. The generated video signal hg4 has the output format in which the processes as shown in FIG. 8(c) are performed for each case, for example, when the camera head 51 is connected, and when the camera head 52 is connected.

5) Switching of Connector

The switch control signal cg is outputted, and thereby, either of the connectors 22a, 22b is selected, or either of the connectors 23a, 23b is selected. Accordingly, the appropriate connector complying with the CCD format is selected, and the video signal is outputted via the selected connector. For example, when the camera head 51 is connected, the connector is a BNC connector, and when the camera head 52 is connected, the connector is a D terminal, and so on.

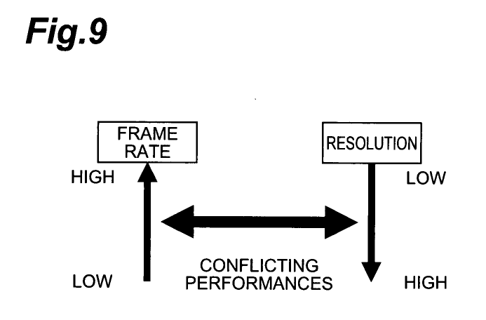

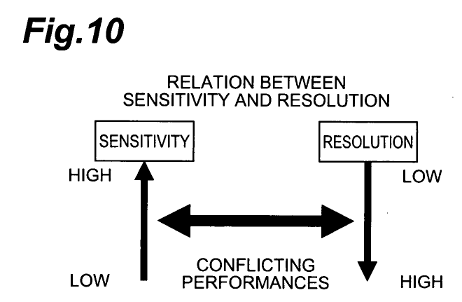

The head detachable camera 1 having the configuration as stated above and operating as stated above has operations and effects as follows. For example, in a head detachable camera for image processing used for a machine vision, two performances of high- and low-frame rates and high- and low-resolutions are conflicting (refer to FIG. 9). Namely, a high-resolution camera has low frame rate (output speed is slow), on the other hand, if it has high frame rate, it becomes low-resolution. Two performances of high- and low-sensitivities and high- and low-resolutions are also conflicting as shown in FIG. 10 in a camera for an endoscope.

In a conventional head detachable camera, it was necessary to distinguish a case when a high-resolution head is connected and when a high frame rate or high-sensitive head is connected.

However, in the head detachable camera 1, the drive signal and video signal complying with the CCD format are generated, and further, the video signal is outputted in the output format complying with the CCD format by outputting the switch control signal cg from the MPU 20 based on the discrimination result by the head discrimination circuit 19. Accordingly, it becomes possible to connect both the high-resolution head and high frame rate head to the same CCU 10 because an appropriate process complying with the CCD format of the connected head is performed even if the head having different CCD format is connected (for example, the head 52 is connected instead of the head 51).

Consequently, in the head detachable camera 1, when plural head detachable cameras are structured such as the cases when the high-resolution head is used and when the high frame rate head is used, only the camera head is to be changed. Besides, it is not necessary to change the CCU 10 in the head detachable camera 1.

In the head detachable camera 1, it is possible to use the same CCU 10 for plural heads. Accordingly, it is not necessary to prepare plural CCUs by purchasing them and so on, even for a user using plural camera heads, and therefore, a low cost can be realized.

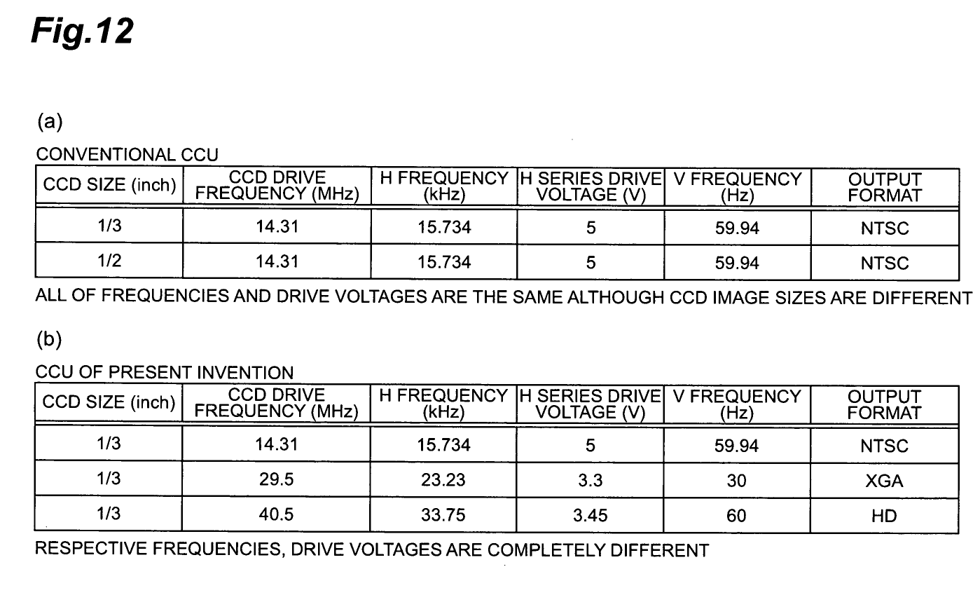

Further, in the conventional head detachable camera, a drive frequency and so on of the CCU is common, and only the head having the same CCD format can be handled even if separate CCDs having different sizes, such as ⅓ inch and ½ inch, can be connected, as shown in FIG. 12(a).

On the contrary, in the head detachable camera 1 of the present invention, the drive frequency and so on becomes appropriate in accordance with the difference of the CCD formats, even if the inch sizes are the same ⅓ inch as shown in FIG. 12(b), and therefore, it is possible to connect plural camera heads having different CCD formats.

As stated above, in the head detachable camera 1, when there is a need to use several types of camera heads, it is only required to exchange and connect the camera head suitable for each use, for the same CCU 10, and it is not necessary to exchange the CCU 10.

Incidentally, in the above-stated camera control unit, there is a case when a camera head other than the camera heads 51, 52 (for example, camera head 53) is connected. In such a case, the process is to be performed in accordance with the head other than the camera heads 51, 52 (for example, camera head 53). In this case, a configuration capable of performing the process in accordance with the camera head other than the camera heads 51, 52 (for example, camera head 53) is to be provided in the digital signal processor 15, output format converter 16, timing generator 17, digital connector 22, analog connector 23, and oscillation circuit 25. For example, a DVI connector is provided in the digital connector 22 and so on to correspond to the case of a head in PC format.

Incidentally, the CCU 10 discriminates the CCD format to output the discrimination signal sg, but the camera head may output a format signal showing the format of the CCD on which it is mounted to the CCU 10, and the CCU 10 may switch the operation such as the generation of the drive signal based on the format signal.

The circuits described in the above-stated embodiment (the head discrimination circuit 19, oscillation circuit 25, PLL circuits 27a, 27b, timing generator 17, digital signal processor 15, output format converter 16, digital connector 22 and analog connector 23) are the circuits being an example to realize the present invention. The present invention can be applied for a head detachable camera using circuits capable of realizing the present invention other than the above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head detachable camera, comprising:
a camera head including an image pickup device; and
a camera control unit to which said camera head is connected, and
wherein said camera control unit includes:
a drive signal generation unit including plural drive signal generators generating a drive signal different by each format of the image pickup device to drive the image pickup device;
a video signal generation unit including plural video signal generators generating a video signal different by each format of the image pickup device based on an image pickup signal outputted from the image pickup device;
a format conversion unit including plural converters converting the video signal generated by the video signal generation unit into an output format different by each format of the image pickup device; and
a switching unit switching the drive signal generator, video signal generator, and converter to be activated in accordance with the format of the image pickup device, from among the plural drive signal generators, the plural video signal generators, and the plural converters.

2. The head detachable camera according to claim 1,
wherein said camera control unit further includes a discrimination unit discriminating the format of the image pickup device, and
wherein the switching unit switches the drive signal generator, video signal generator, and converter to be activated based on a discrimination result of the discrimination unit.

3. The head detachable camera according to claim 2,
wherein said camera control unit further includes a manual switch capable of manual operation, and
wherein the discrimination unit discriminates the format of the image pickup device in accordance with the manual operation of the manual switch.

4. The head detachable camera according to claim 2,
wherein the discrimination unit discriminates the format of the image pickup device in accordance with a vacant terminal of a cable to connect said camera head and said camera control unit.

5. The head detachable camera according to claim 2,
wherein said camera head further includes a format information storage device storing format information capable of specifying the format of the image pickup device,
wherein said camera control unit further includes a format information reading unit reading the format information stored in the format information storage device, and
wherein the discrimination unit discriminates the format of the image pickup device in accordance with the format information read by the format information reading unit.

6. The head detachable camera according to claim 1, further comprising:
an oscillation device including plural oscillators oscillating with a frequency different by each format of the image pickup device, and
wherein the switching unit switches the oscillator to be activated in accordance with the format of the image pickup device.

7. The head detachable camera according to claim 2, further comprising:
an oscillation device including plural oscillators oscillating with a frequency different by each format of the image pickup device, and
wherein the switching unit switches the oscillator to be activated in accordance with the format of the image pickup device.

8. The head detachable camera according to claim 3, further comprising:
an oscillation device including plural oscillators oscillating with a frequency different by each format of the image pickup device, and
wherein the switching unit switches the oscillator to be activated in accordance with the format of the image pickup device.

9. The head detachable camera according to claim 4, further comprising:
an oscillation device including plural oscillators oscillating with a frequency different by each format of the image pickup device, and
wherein the switching unit switches the oscillator to be activated in accordance with the format of the image pickup device.

10. The head detachable camera according to claim 5, further comprising:
an oscillation device including plural oscillators oscillating with a frequency different by each format of the image pickup device, and
wherein the switching unit switches the oscillator to be activated in accordance with the format of the image pickup device.

11. The head detachable camera according to claim 5,
wherein said oscillation device includes plural PLL circuits generating an operation clock different by each format of the image pickup device, and
wherein the switching unit switches the PLL circuit to be activated in accordance with the format of the image pickup device.

12. A camera head constituting a head detachable camera having the camera head including an image pickup device, and a camera control unit to which the camera head is connected, said camera head comprising:
a format information storage device storing format information capable of specifying a format of the image pickup device.

13. A camera control unit constituting a head detachable camera having a camera head including an image pickup device, and the camera control unit to which the camera head is connected, said camera control unit comprising:
a drive signal generation unit including plural drive signal generators generating a drive signal different by each format of the image pickup device to drive the image pickup device;
a video signal generation unit including plural video signal generators generating a video signal different by each format of the image pickup device based on an image pickup signal outputted from the image pickup device;
a format conversion unit including plural converters converting the video signal generated by said video signal generation unit into an output format different by each format of the image pickup device; and
a switching unit switching the drive signal generator, video signal generator, and converter to be activated in accordance with the format of the image pickup device from among the plural drive signal generators, the plural video signal generators, and the plural converters.
